(19) United States
(12) Patent Application Publication
(10) Pub. No.: US 2018/0248459 A1
(43) Pub. Date: Aug. 30, 2018

(54) Extendable compact structure having one or plurality of permanent magnets for driving Electrical Generator

(71) Applicants: Zeyad AL-MAADHEEDI, Selangor (MY); Fawaz AL-JOBORY, Caparica (PT)

(72) Inventor: Fawaz Saleem Al-Jobory, Caparica (PT)

(21) Appl. No.: 15/932,148

(22) PCT Filed: Sep. 22, 2015
(86) PCT No.: PCT/IB2015/057296

§ 371 Date: Feb. 9, 2018

(51) Int. Cl. H02K 35/02; H02K 7/075; H02K 7/18; H02K 7/02

(52) U.S. Cl. CPC H02K 35/02; H02K 7/075; H02K 53/00; H02K 7/025; H02K 7/1876

(57) ABSTRACT

The present invention subject matters relates to build and operate extendable, compact solid structure holds multi numbers of permanent magnets and coupled to electrical generator in order to drive its rotor's shaft (11) and convert the energy of the permanent magnets “sources of renewable energy” into electric energy efficiently, wherein the present invention solid structure can be considered as renewable energy drive system compressed of permanent magnets (4) and electromagnets (5) fixed together in one solid structure and coupled to electrical generator (10) for driving the rotor's shaft (11) of the electrical generator (10) by the magnetic force/energy of the permanent magnets “the renewable energy source” and produce the electric energy. The solid structure of the present invention can be arranged in multi cells (1) design, wherein each cell (1) that consists of movable frame (2) holds permanent magnets (4) and sliding along the unmovable frame (3) of the same cell (1) that holds the electromagnets (5). The operation principle of the present invention based mainly on The oscillated attraction and repulsion forces/energy produced between two sources of the magnetic force/energy (the permanent magnets (4) and electromagnets (5)) during the operation of the system in accordance to the changing polarity of the alternating current passing through the electromagnet coils (7) of the electromagnet (5), wherein the produced attraction and repulsion force/energy is a summation of the permanent magnets force/energy and electromagnets force/energy that will be transferred and applied to rotor's shaft (11) of the A.C. electrical generator (10) as an oscillating power/mechanical power of the movable frame (2) in a frequency equal to alternating current's frequency passing through the electromagnets coil (7) that in line/in phase with rotation direction and speed of the rotor's shaft (11) of the A.C. electric generator (10). The A.C. electric generator (10) continuously converts the oscillating power/mechanical power of the movable part (2) into electric energy that feed the connected electric load as long as the reversed electromagnetic force/torque produced by the electric generator (10) during load condition is less than the attraction and repulsion forces between all permanent magnets forces and all electromagnets available inside the present invention Non-ferromagnetic solid structure and electrical load required energy is less that the permanent's magnet energy according to energy conversion law; Input energy=Loss energy+Output Load energy. To be note, the present invention system able to operate according to the following four different applications/tasks by implements simple changes on the connection between its equipment;
1—Off-Grid renewable power generating system that able to convert the permanent magnets energy into electrical energy.
2—On-Grid renewable power generating system that able to convert the permanent magnets energy into electrical energy.
3—Mechanical power magnifying system that able to add the permanent magnetic force/energy to the renewable mechanical energy applied to the input of the A.C. electrical generator via its related turbine.
4—Electrical power magnifying system that able to add the permanent magnetic force/energy to the electrical energy applied to the input of the electrical generator.
5—Inverter that able to convert the input D.C electrical power into output A.C. electrical power.

### FIELD OF THE INVENTION

The present invention is related in general to renewable energy generation and specifically to build extendable compact solid structure holds multi numbers (plurality) of permanent magnets as a renewable energy source that able to drive the rotor's shaft of its coupled electrical generator by the magnetic field/force of the permanent magnets in order to produce the electrical energy efficiently, wherein the extendable compact solid structure can be fixed on the body of the coupled electrical generator.

### BACKGROUND OF THE INVENTION

There are many methods for producing the electric energy by using the renewable energy sources available in nature such as sun energy, wind energy, sea energy and etc. . . . , stills the scientists and research centers searching for additional efficient renewable sources of energy and trying to build efficient renewable energy generating system to cover the global increased demand on electric energy. The present invention focuses and uses the permanent magnet as one of the renewable energy sources available in nature. Although there are many methods has been developed to use the permanent magnet as one of the renewable energy source available in nature in order to produce the electric energy, But. Still the designed or the built systems inefficient to compete other available/conventional renewable energy generation systems. The present invention has been developed in order to solve the most challenge issues and limitations on using the permanent magnet as a source of renewable energy and increase its operation's efficiency on producing the electric power, wherein the present invention presents;
New method for arranging multi numbers (plurality) of permanent magnets together inside one compact solid structure in order to increase the total effective area of permanent magnets which the magnet flux passes through it and increase the total permanent magnet energy per available volume of the system; and
Extendable solid structure that can be easily adding additional number of the permanent magnets “source of renewable energy” to the existing one to increase the renewable energy sources available inside the system to suit the required application; and
the present invention system is coupled to conventional electric generator that already available in the markets at reasonable cost in order to produce the electric power without required to invent or manufacture new design generator to suit and coupled to present invention system, as a result reduce the cost of the System and reduces the cost of electric power production by the permanent magnets.
Furthermore by implement simple changes to the connection between its equipment, the present invention system able to perform the following five different applications in accordance to its energy flow and energy conversion low; Off-grid power generating, On-Grid power generating, mechanical power magnifying, electrical power magnifying and power inverting.
Important Note: In General the magnetic field/energy produced by the permanent magnet can be used in different applications such as in generator application when the permanent magnet fixed inside the electrical generator as a source of magnetic field in order to intersect with the coils of the electrical generator and produce the electrical current via driving the rotor's shaft by external driving source. But, in the present invention system we are using the permanent magnet's magnetic force/energy as a renewable drive's force/energy source that able to drive the rotor's shaft of the coupled electrical generator and produce the electrical current whatever the coupled electrical generator is a synchronous generator or permanent magnet generator. So, the present invention is an extendable, compact's design renewable energy drive system fixed on the electrical generator's body and drive its rotor's shaft to produce the electric power efficiently and cost effectively that able to compete other available/conventional renewable energy generation systems and cover the domestic demand of electric power.

### SUMMARY OF THE INVENTION

The object of the present invention is to build an efficient and cost effective extendable solid structure that able to fixed on the body of the electrical generator and holds multi numbers (plurality) of permanent magnets “sources of renewable energy” and electromagnets in order to drive the rotor's shaft of the coupled electrical generator and produce the electric power via the Attraction and repulsion magnetic force/energy generated between the permanent magnets and electromagnets. The operation and advantage of the present invention system is based on scientific fact that the attraction and repulsion force/energy generated between the permanent magnets (first/renewable magnetic field source) and the electromagnets (Second magnetic field source) is equal to summation of both forces/energies as following formula (1):

$$\begin{matrix}Generated Attraction \text{/} repulsion \\ Magnetic force \text{/} energy \end{matrix} = \begin{matrix}Magnetic force \text{/} energy of \\ the permanent magnets \end{matrix} + \begin{matrix}Electromagnetic force \text{/} energy of \\ the electromagnets \end{matrix} \qquad ( 1 )$$

The extendable solid stricture of the present invention can be compressed of multi number of cells fixed together, each cell compressed of two frames; Movable and unmovable that holds both permanent magnets and electromagnets, wherein the movable frame sliding along the unmovable frame based on the attraction and repulsion force between the permanent magnets and electromagnets. According to the solid structure design of the present invention, the movable frame holds the permanent magnets while the unmovable frame holds the electromagnets; on the contrary the unmovable frame can hold the permanent magnets while the movable frame can hold the electromagnets according to the design of the cell. Due to attraction and repulsion forces generated between the permanent magnets and electromagnets, the movable frame of each cell moves in linear oscillating motion to drive the rotor's shaft of the electrical generator in rotating speed indirectly via linear to rotation motion transducer includes camshaft or directly in case of using linear electrical generator. The most important advantage of the Non-ferromagnetic extendable solid structure of the present invention its ability on hold multi numbers (plurality) of large size permanent magnets in compact and extendable volume then collect/pass all the magnates forces/energies of all permanent magnets held by the present invention structure and apply it/transfer it all together at same time to the rotor's shaft of the coupled generator to drive it.

To be note, the present invention systems able to operate according to the following five different applications/tasks by implement simple changes on the connection between its equipment;
1—Off-Grid renewable power generating system that able to convert the permanent magnets energy into electrical energy.
2—On-Grid renewable power generating system that able to convert the permanent magnets energy into electrical energy by mix/add it with electrical energy.
3—Mechanical power magnifying system that able to add the permanent magnetic force/energy to the renewable mechanical energy applied to the input of the A.C. electrical generator via its related turbine.
4—Electrical power magnifying system that able to add the permanent magnetic force/energy to the electrical energy applied to the input of the electrical generator.
5—Inverter that able to convert the input D.C electrical power into output A.C. electrical power.

The five different applications/tasks of the present invention can be assessed separately in respect to its energy flow and energy conversion low. Further description of the current invention are in the following detailed description of the invention, other feature and advantages of the current invention will become appear from the following detailed description.

### BRIEF DESCRIPTION OF THE DRAWINGS

FIG. 1/13: includes sub figures (1a, 1b, 1c & 1d) shows different models of the Non-ferromagnetic cell “the main part of the present invention”, wherein each cell compressed of movable solid frame that holds the Permanent magnets sliding on unmovable solid frame that holds the electromagnets.

FIG. 2/13: shows the electric circuit diagram for connecting the electromagnets that fixed on each cell of the present invention to the output of the A.C. electrical generator.

FIG. 3/13: includes the sub figures (3a, 3b) shows the front and side view Non-ferromagnetic extendable solid structure of the present invention consist of two cells that fixed on the front & rear sides of the conventional A.C. electrical generator in order to drive its rotor's shaft.

FIG. 4/13: shows the second coupling method of the movable part of the Non-ferromagnetic solid structure/cell of the present invention of FIG. 3 coupled to the rotor's shaft of the generator indirectly via speed reduce gearbox.

FIG. 5/13: shows another new design of the present invention by adding new equipment to the Non-ferromagnetic solid frame/cell.

FIG. 6/13: includes sub figures (6a, 6b, 6c and 6d) shows the fourth methods and auxiliary equipment for starting the operation of the present invention system and producing the electric power.

FIG. 7/13: is a schematic block diagram shows the first application of the present invention system (Off-Grid renewable power generating system), related equipment and its connection for converting the permanent magnets energy into electrical energy.

FIG. 8/13: is a flow chart shows the staring and operating sequence of the first application (Off-Grid renewable power generating system) of the present invention system for converting the permanent magnets energy into electrical energy.

FIG. 9/13: includes sub figures (9a, 9b, 9c and 9d) shows different design and installation methods of the present invention system in order to increase its energy capacity.

FIG. 10/13: is a schematic block diagram shows the Second application of the present invention system (On-Grid renewable power generating system), related equipment and its connection.

FIG. 11/13: is a schematic block diagram shows the Third application of the present invention system (Mechanical power magnifying system), related equipment and its connection.

FIG. 12/13: is a schematic block diagram shows the Fourth application of the present invention system (Electrical power magnifying system), related equipment and its connection.

FIG. 13/13: is a schematic block diagram shows the Five application of the present invention system (Electrical Inverter system), related equipment and its connection for converting the input D.C electrical power into output A.C. electrical power.

### DETAILED DESCRIPTION OF PREFERRED EMBODIMENTS

Reference now will be in detail to embodiments of the invention, one or more examples of which are illustrated in the drawings. Each example is provided by way of explanation of the invention, not limitation of the invention. It will be apparent to those skilled in the art of various modifications and variation can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents. Reference will now be made in detail to the presently preferred embodiments of using the extendable, compact solid stricture holds permanent magnets as a renewable energy sources for driving the electrical generator. Refereeing now to the drawings;

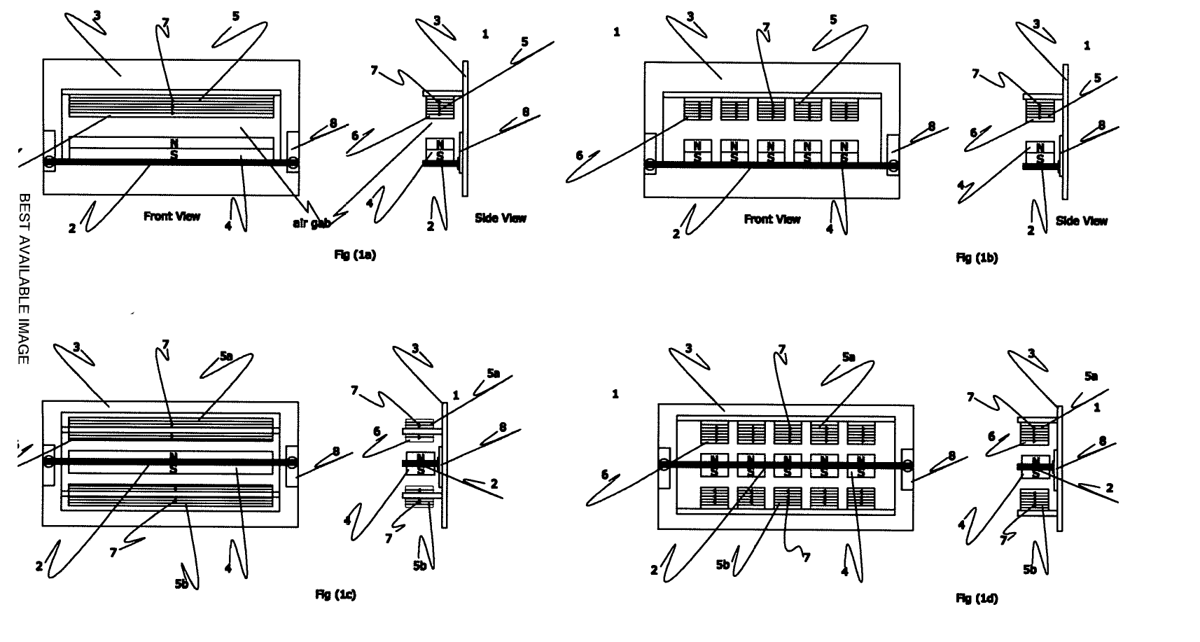

FIG. 1/13: includes sub figures (1a, 1b, 1c, 1d) illustrate different models of the main part (Non ferromagnetic solid cell (1)) of the present invention holds the Permanent magnets (4) “the source of renewable energy” and the electromagnets (5), wherein the permanent magnet (4) fixed on the movable frame (2) of the cell (1) while the electromagnets (5) fixed on the unmovable frame (3), vice versa and based on the cell's design, the permanent magnet (4) can be fixed on the unmovable frame (3) of the solid cell (1), while the electromagnet (5) can be fixed on the movable frame (2). The cell (1) is the most important/main part of the present invention system that consist of movable frame (2) sliding along the unmovable frame (3) via rail & bearing (8) or any other means of sliding equipment. The cell (1) can be designed in different shape and structure as illustrate and not limited to below models;

Model A, FIG. 1a shows one Block Permanent magnet (4) fixed on the movable frame (2) of the solid cell (1), while the electromagnet (5) that consists of ferromagnetic metal (6) and coil (7) turned around it fixed on the unmovable frame (3) of the solid cell (1).

Model B, FIG. 1b shows multi numbers of small Permanent magnets (4) fixed and arranged together on the movable frame (2) of the solid cell (1) and multi numbers of small electromagnets (5) that consist of ferromagnetic metal (6) and coil (7) turned around it fixed, arranged and connected electrically “in parallel or series” together on the unmovable frame (3) of the solid cell (1).

Model C, FIG. 1c shows one large Permanent magnet (4) fixed on movable frame (2) of the solid cell (1) moves between two electromagnets (5a & 5b) when the first electromagnet (5a) in attraction force with permanent magnet (4), the second electromagnet (5b) in repulsion with the permanent magnet (4), this can be achieved according to turning direction of coil (7) around the ferromagnetic metal (6) of the electromagnets (5a & 5b) based on faraday's law and right hand rule, wherein the winding turning direction of the first electromagnet (5a) is opposite to the winding turning direction of the second one (5b).

Model D, FIG. 1d shows multi numbers of small Permanent magnets (4) fixed and arranged together on movable frame (2) of the solid cell (1) moves between two sets of electromagnets (5a & 5b), when the first set of the electromagnets (5a) in attraction force with permanent magnets set (4), the second set of the electromagnets (5b) in repulsion with the permanent magnets set (4), this can be achieved according to turning direction of coil (7) around the ferromagnetic metal (6) of each electromagnet of set (5a & 5b) based on faraday's law and right hand rule, wherein the winding direction of the first electromagnets set (5a) is opposite to the winding turning direction of the second one (5b).

IMPORTANT NOTE: The present invention has been designed with very short operating displacement of movable frame (2) along the unmovable frame (3) on each cell (1) in order to operate under maximum strength area of the magnetic field/force produced by the permanent magnet (4) that proportional reversely with the air gap's length between the permanent magnet (4) and the electromagnets (5).

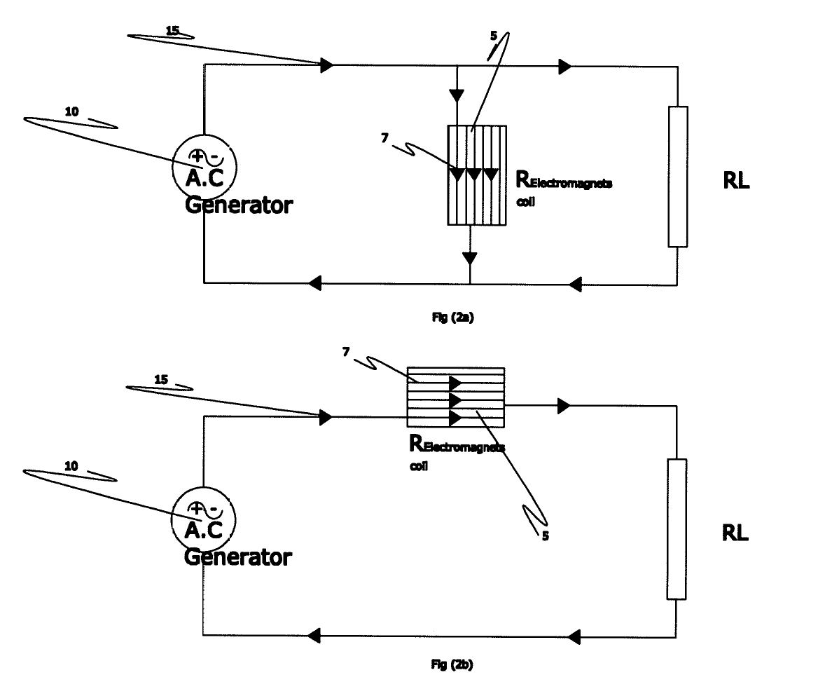

FIG. 2/13: includes sub figures 2a & 2b shows the electric circuit diagram for connecting the electromagnetic (5) to the output of the coupled A.C. electrical generator (10) of the present invention, wherein according to required design and application, the coil (7) of the electromagnet (5) can be connected in parallel as in sub figure (2a) or in series as in sub figure (2b) to the output of the A.C. electric generator (10), the frequency of the alternating current (15) passing through the coil (7) of the electromagnet (5) is based on the following A.C. generator's formula;

f=PN/120 (2)

Where f is a frequency of the alternating output current, P is a number of poles; N is a rotation speed of rotor's shafts (rpm).

So, the polarity of the electromagnet (5) will be changed from north to south and vise versa according to change on the polarity of alternating current (15) according to faradays' law and right hand rule. Since the electromagnet (5) is fixed on the unmovable solid frame (3) of the cell (1) of the present invention and the permanent magnate (4) is fixed on the movable frame (2) shown in FIGS. 1 & 2, changing the polarity of the electromagnet (5) makes the movable frame (2) that holds the permanent magnets (4) “the source of renewable energy” oscillate up and down due to attracting and repulsion forces between the permanent magnets (4) force and electromagnet (5) force at frequency equal to the frequency of the alternating current (15) passing in the electromagnet's coil (7). To be note according to the present invention, the permanent magnets (4) are the only available sources of the renewable energy, wherein the generated attraction and repulsion forces are equal to summation between the magnetic force produced by permanent magnets (4) and the magnetic force produced by the electromagnets (5), hence the electromagnet's coil (7) may be designed with low number of conductor's turns (based on practical design) in order to keep the attraction and repulsion force between the magnets (4&5) based mainly on the strength of the permanent magnets (4) force “source of renewable energy” and reduce the inductance/reactance loss during the changing of the A.C. current polarity passing through the electromagnet's coil (7).

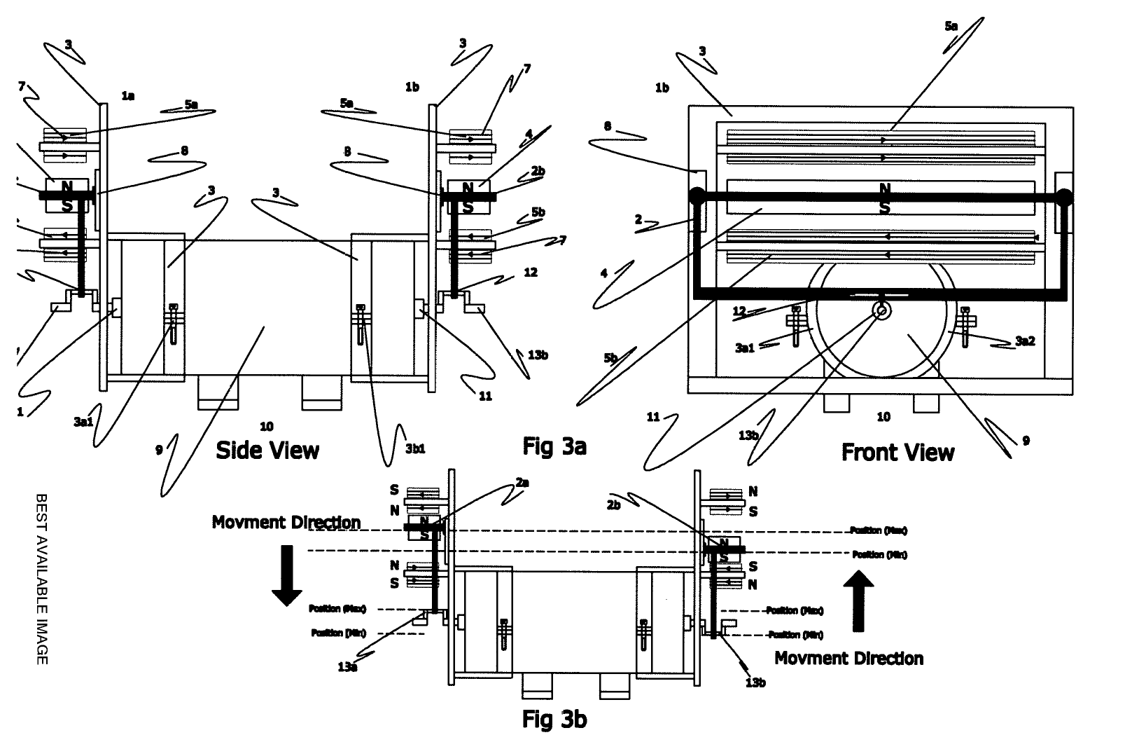

FIG. 3/13: includes sub figures 3a & 3b illustrate the front and side view Non-ferromagnetic extendable solid structure of the present invention consist of two cells (1a & 1b) that fixed on the body (9) of the A.C electrical generator (10) and drive its rotor's shaft (11), wherein the down end edge of the movable frame (2) has rectangular opening which the U-shape part of the camshaft (13) sliding inside the it in order to form the linear to rotational motion transducer mechanism (12) that convert the linear motion of the movable frame (2) into rotational motion, the unmovable frame (3) of the present invention is coupled to the body (9) of the conventional electric generator (10) and tighten by the bolts (3a1, 3a2, 3b1&3b2), while the camshaft (13) is coupled between down end edge “rectangular opening” of the movable frame (2) and the terminal of the rotor's shaft (11) of the electric generator (10) to drive it in rotation velocity, while the electrical output terminals of the coupled A.C. Electrical generator (10) are connected to both electromagnets (5a & 5b) and the electrical load as shown and illustrated under drawing FIG. 2/13.

In operation; the system will be started via external mechanical power applied “at starting only” on the rotor's shaft (11) of the A.C. electrical generator (10) for providing preliminary starting push that start rotating and accelerating the rotor's shaft (11) of the A.C. electrical generator (10) to designed speed according to charged kinetic energy inside the system in order to start producing the electric power that proportional to the input mechanical power;

EI=Tw (3)

Where E=electromotive force (emf), I=A.C. output current, T=torque of the input mechanical power N·m, ω=angular velocity (rad/s) of the input mechanical power.

once the rotor's shaft (11) start rotating at external mechanical power's speed, the A.C. Electrical generator (10) start producing the electric power and the A.C. Current start passing through the electromagnet coil (7) of the electromagnets (5a&5b), hence the attraction and repulsion forces generate between the permanents magnets (4) and the electromagnets (5a&5b) in accordance to the A.C. Current polarity/direction passing through electromagnet coil (7) that reverse its polarity based on the rotation and speed of the rotor's haft (11) “each half rotation cycle in case of 2 poles A.C. electrical generator and in accordance to following formula (2); f=PN/120”, as a result and since the permanent magnets (4) fixed on the movable frame (2), the permanent magnets (4) start oscillate in linear movement between the electromagnets (5a&5b) in accordance to the A.C. Current polarity/direction passing through electromagnet coil (7), when the permanent magnet (4) in attraction force with electromagnet (5a), at a meantime it will be in repulsion force with electromagnet (5b) “as illustrated previously under above mentioned explanation of FIG. 1/13, as a result the attraction and repulsion force/energy will be applied continuously on the movable frame (2) that holding the permanent magnet (4) of each cell (1) and transferred it to the rotor's shaft (11) of the A.C. Electrical generator (10) via the linear to rotational movement transducer includes the camshaft (13) during the linear oscillation movement of the permanent magnets (4) between the electromagnets (5a&5b) at speed equal to the speed of the external starting applied mechanical power, wherein the permanent magnets “source of renewable energy” will keep adding energy to the system at system oscillating speed and in phase with the rotor's shaft (11) movement direction that helps the system after decupling of the input mechanical power to keep continuously storing the charged kinetic energy inside the system that keep rotating the rotor's shaft (11) at its designed speed and keep producing the electric power as long as the reversed electromagnetic torque produced inside the coupled A.C. electrical generator (10) at load condition is less than the attraction and repulsion force between the permanent's magnets (4) and electromagnets (5a&5b) and the required electrical load energy is less than the permanent's magnet energy according to energy conversion law; Input energy=Loss energy+Output Load energy

It is of course, the system needs to be accelerated by the external starting mechanical power prior to decoupling it to reach and pass certain speed “cut in speed according to the design of the system” in order to keep continuously rotating the rotor's shaft (11) after decoupling of the external starting mechanical power where the input power produced by the oscillated permanent magnets between the electromagnets (5a&5b) that applied to the rotor's shaft (11) via the movable frame (2) and camshaft (13) is exactly equal or greater than the system power loss plus the load power (Input permanent magnets Power=loss Power+output load Power).

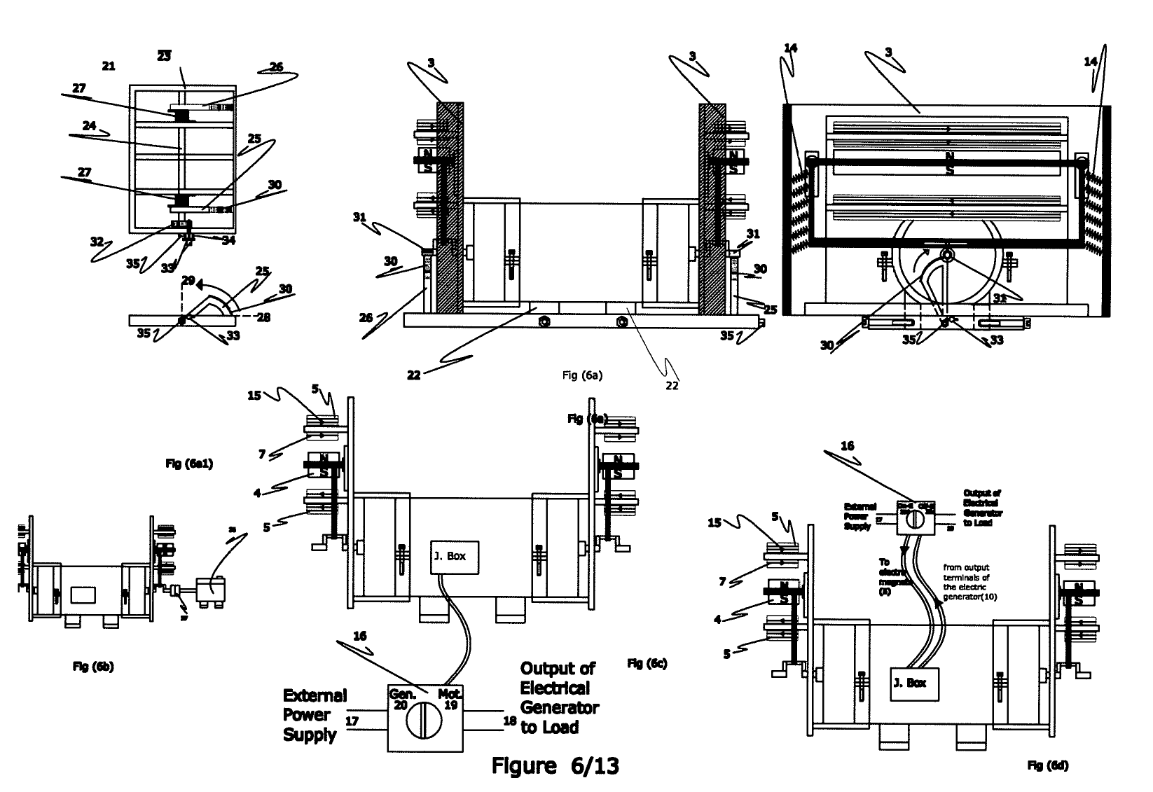

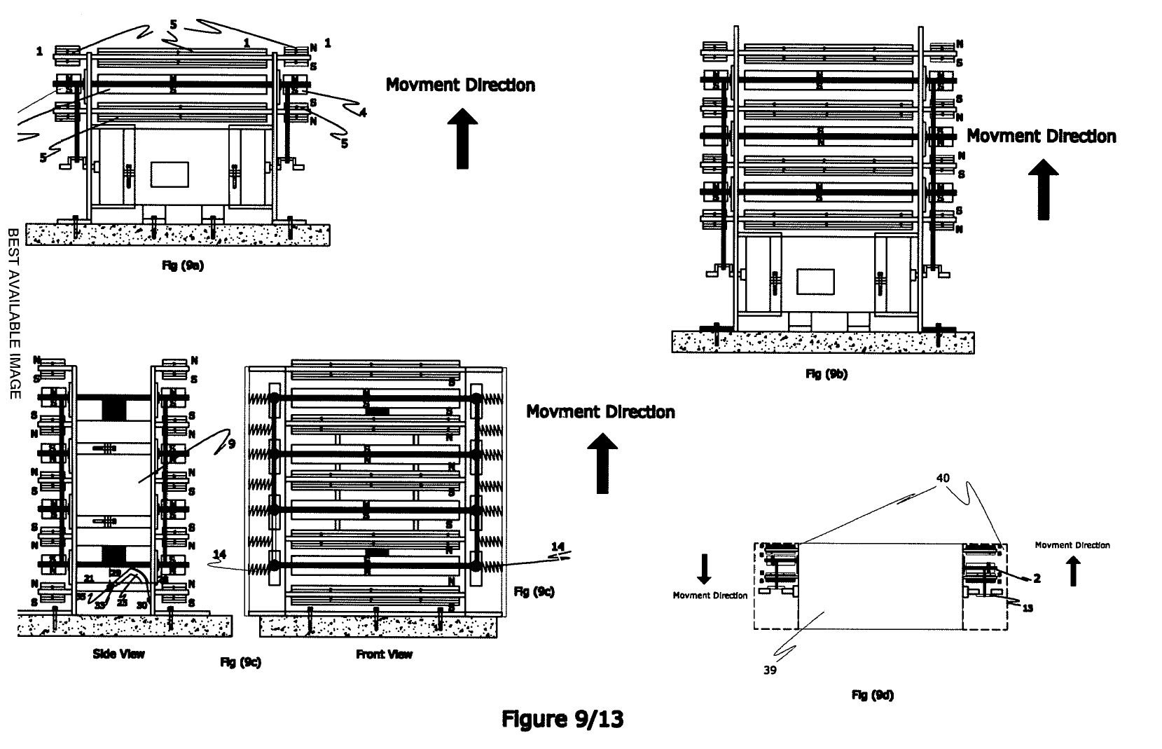

To be note, the permanent magnetic force/energy has to be applied on the rotor's shaft (11) of the A.C. electrical generator (10) in line with its rotation direction, this can be achieved by calibrating the coupling position between the camshaft (13) and the rotor's shaft (11) in such position when the permanent magnets (4)/frame (2) reach its maximum upper or lower points during its linear oscillated movement between the electromagnets (5a &5b) and start reverse its direction, the produced A.C. Current passing through electromagnet coil (7) start reverse its polarity in order to apply the generate attraction and repulsion force/energy between the permanent magnets (4) and electromagnets (5a&5b) on the rotor's shaft (11) in line/in phase with its movement direction that enhance its rotation “Detailed explanation as illustrated and shown under drawing, FIG. 6/13 and its related explanation”. Furthermore, in accordance to sub figure 3a the system can be designed wherein both the movable frame (2a) of the rear cell (1a) and the movable frame (2b) of the front cell (1b) to start moves together in same direction from the maximum upper displacement point towered the minimum lower displacement point then reverse its movement direction together (based on the A.C. Current polarity passing through the electromagnets (5a & 5b)) from minimum lower displacement point towered the maximum upper displacement point. as another option, the system can be designed in accordance to sub figure 3b based on the coil's (7) turn direction of the electromagnet (5a & 5b) and the coupling position of the camshafts (13a and 13b) in such way when the movable frame (2a) of the rear cell (1a) start moves from the maximum upper displacement point (Max) towered the minimum lower displacement point (Min), the movable frame (2b) of the front cell (1b) start moves in opposite direction from minimum lower displacement point (Min) towered the upper displacement point (Max) as shown in sub figure (3b) which is similar to car's engine technique on transferring the energy from the combustion chamber to the engine's camshaft. In additional to above mentioned information and as another design's option, the current invention solid structure can be fixed on the body of flywheel energy storage (39) as shown under subfigure 9d of FIG. 9/13 or inside the flywheel energy storage (39) vacuumed compartment as shown under subfigure 9e of FIG. 9/13 in order to add the magnet force/energy of the permanent magnet continuously to the flywheel rotating shaft to compensate the small loss due to high speed motion around (20,000 to 40,000 RPM) of the flywheel shaft which helps to keep storing the kinetic energy inside the flywheel for long time as well as get the high advantage of the high continuity speed of the flywheel shaft to get continuous output power proportional to the magnetic force of the permanent magnets (4) multiply by the high speed of flywheel shaft as long as the reversed electromagnetic torque produced inside the coupled flywheel energy storage (39) at load condition is less than the attraction and repulsion force between the permanent's magnets (4) and electromagnets (5a&5b) and the required electrical load energy is less than the permanent's magnet energy according to energy conversion law; Input energy=Loss energy+Output Load energy

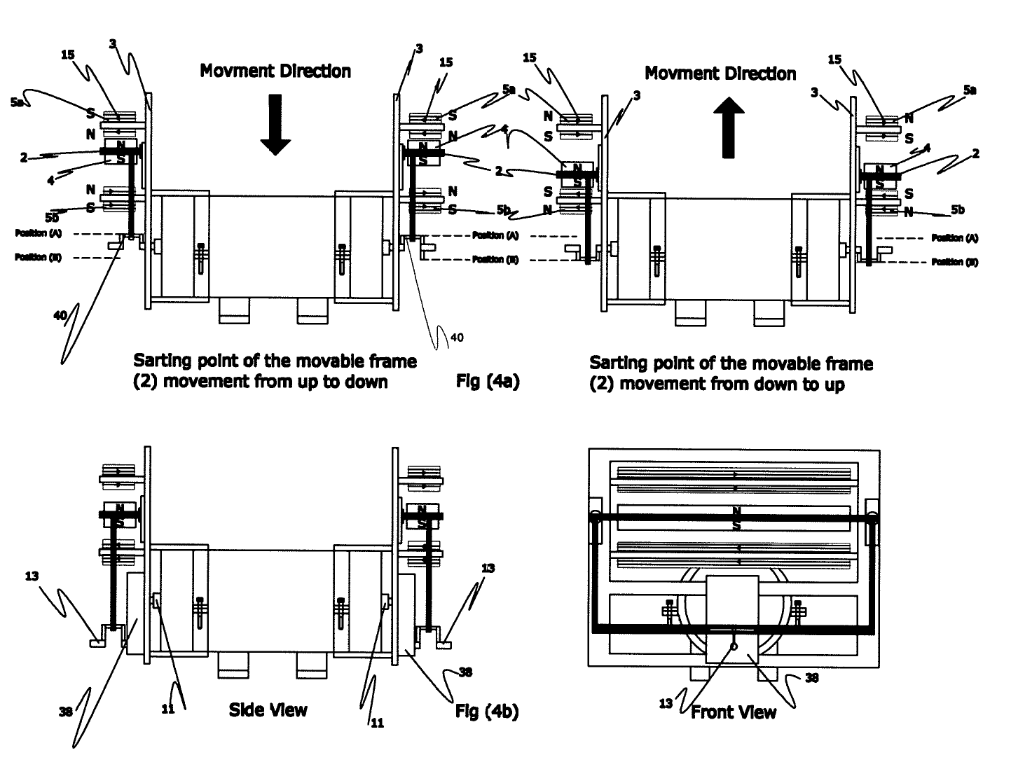

FIG. 4/13: shows the second coupling method between the movable frame (2) of the Non-ferromagnetic solid structure/cell (1) of FIGS. 1/13 to 3/13 and the rotor's shaft (11) of the coupled A.C. electric generator (10), wherein based on FIGS. 2/13 & 3/13 that using the 2 poles A.C. electrical generator, the camshaft (13) has to be fixed and adjust in such position that make the attraction and repulsion forces between the permanent magnets (4) and electromagnets (5a & 5b) applied to the frame (2) and the rotor's shaft (11) at the same phase (in line) of the oscillation of the frame (2) and the rotation of the rotor's shaft (11) that helps to keep adding the energy of the permanent magnets (4) efficiently to the present invention system to drive the coupled rotor's shaft (11), wherein the camshaft (13) has to be fixed/coupled and adjust to the rotor's shaft (11) in such position when its U-Shape frame (40) that coupled and sliding inside the rectangular opening (12) of frame (2) start rotate and move from position (A) towered position (B) shown in subfigure 4a, the movable frame (2) that holds the permanent magnet (4) start moves also linearly from up to down and the A.C. current produced by the A.C. Electrical generator and passing through the electromagnets (5a & 5b) in such direction/polarity that produce repulsion force between electromagnet (5a) and permanent magnet (4) at the meantime it produce attraction force between electromagnet (5b) and permanent magnet (4), when the U-Shape frame (40) accede position (B) and reverse back towered position (A), the polarity of the output current (15) of the 2 poles A.C. electric generator (10) has to be reversed immediately, as a result the polarity of the current passing through the electromagnet's coil (5a&5b) will be reversed also that reverse the polarity of the electromagnets (5a & 5b), wherein the movable frame (2) start moving from down to up due to the continuity of rotor's shaft (11) rotation (moment of inertia) as well as due to start the attraction force between the electromagnet (5a) and the permanent magnet (4) and start the repulsion force between the electromagnets (5b) and the permanent magnets (4) as mentioned previously (in other word, the polarity of the electromagnets (5a&5b) changed in accordance to polarity change of the produced current and in line with the change of movement direction of the U-Shape (40) of the camshaft (13) from up to down or from down to up).

According to above mentioned formula (2); f=PN/120, in case of using and coupling 2 poles A.C. electric generator rotate at 3000 rpm via external starting mechanical power source of FIG. 6/13, the frequency f of the output alternator current (15) produced by the A.C. electric generator that feed back to the electromagnet's coil (7) is equal to 50 HZ “50 Cycle/sec=3000 Cycle/min” that proportional to the speed of rotor's shaft (3000 rpm), at the meantime the oscillation frequency of the movable frame (2) is proportional to the current frequency passing through the electromagnet's coil (7) will be also equal to 50 Cycle/sec “3000 Cycle/min” that match the speed of the rotor's shaft (11) “3000 rpm”, While in case of using 4 poles A.C electric generator rotate at 3000 rpm via external starting mechanical power source of FIG. 6/13, the frequency of the output current (15) that feed back to the electromagnet's coil (7) will be doubled 100 HZ “100 Cycle/sec” according to formula (2), So the frequency of the movable frame (2) will be doubled also and equal to 100 Cycle/sec “6000 Cycle/min” while the speed of the rotor's shaft (11) still the same (3000 rpm), as a consequences the rotor's shaft complete rotation cycle (rpm) not equal nor match the movable frame (2) completed cycle, in this case we have to coupled reduce speed gear box (38) between the camshaft (13) and rotor's shaft (11) as shown in FIG. 4b, the coupled gearbox (38) has reduction speed ratio 2:1 in order to reduce its input speed of the movable frame (2) that applied to coupled camshaft (13) 6000 Cycle/min, wherein the gear box output shaft complete rotation cycle (rpm) will be equal to 3000 rpm that equal and match the rotor's shaft speed of the electrical generator. So the advantages of the coupled gearbox (38) are;
1. Matching the speed of the movable frame (2) due to attraction and repulsion forces between the permanent magnets (4) and the electromagnets (5a&5b) with the speed of rotor's shaft (11) of the A.C. electrical generator during the starting and operation stages, wherein the attraction and repulsion forces will be applied on the rotor's shaft (11) in line “in phase” with its rotation direction.
2. in order to get much benefit from the permanent magnets energy/force that proportion reversely with the air gap between the permanent magnets (4) and the electromagnets (5a & 5b), the present invention has been designed with very short operation displacement of movable frame (2) which is around 15 mm, hence the coupled camshaft (13) dimensions of the present invention is also have very small dimensions that may not able to drive large electrical generator efficiently due to high input torque required to drive such electrical generator, so by using multi poles A.C. Electrical generators and coupling the speed reduction gearbox (38) between the camshaft (13) and the rotor's shaft (11) of the multi poles A.C. electrical generator, although the speed of the movable frame (2) applied on the rotor's shaft will be reduced via the Gear box (38). But, the input force/torque applied on the rotor's shaft (11) via the gear box (38) will be increased which helps to drive large A.C. electrical generator easily and efficiently, wherein the small dimension camshaft (13) will not face the high torque produced by large A.C. Electrical generator at load condition and will be able to drive the input of the reduce speed gearbox (38) easily.

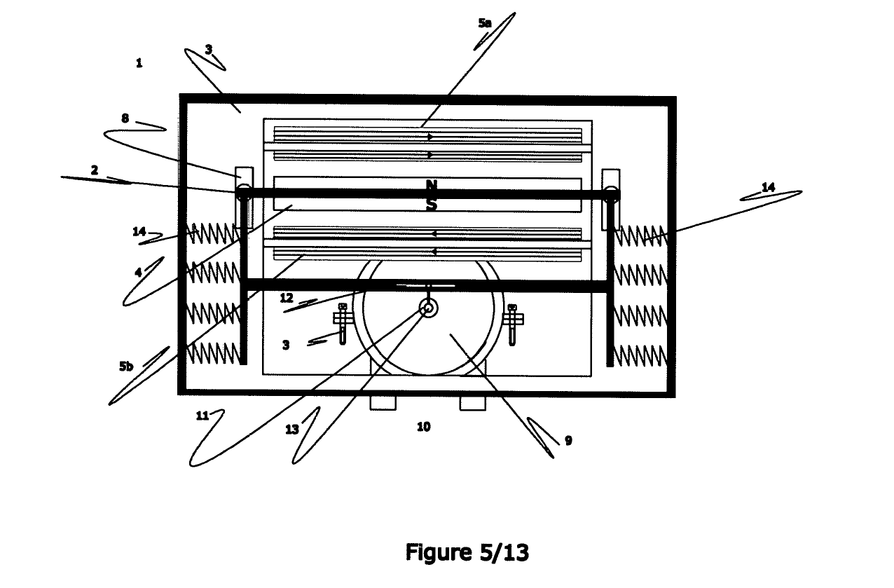

FIG. 5/13: shows another new design of the present invention by adding new equipment to the Non-ferromagnetic solid structures cells (1) of FIGS. 1/13 to 4/13 in order to enhancing the starting and operation of the present invention, wherein the springs (14) coupled between the movable frame (2) and unmovable frame (3) in each cell (1) in order to store the elastic energy (Elastic energy=1/2 Kx̂2) inside the springs gradually by an external power source during the starting process of system and smoothing and balancing the motion of movable frame (2) during its linear oscillating movement from up to down along with earth gravity and from down to up opposite to earth of gravity after releasing the charged springs. according to first method for starting the operation the system as illustrated and shown under below description related to FIG. 6/13, after releasing the charged spring, the discharged kinetic energy (½mv̂2) of the springs starts immediately rotating the rotor's shaft (11), the A.C. electrical generator (10) start producing the electrical power at frequency according to formula (2);

f=PN/120 (2)

Considering the A.C. Electrical generator has 2 poles

f*60 (Cycle/min)=2*N (rpm)/120

f (cycle/min)=N (rpm)

as shown above, the frequency (Cycle/min) of the produced A.C. Current passing through the electromagnet's coil (7) is equal to rotation speed (rpm) of the rotor's shaft (11), since the rotor's shaft rotation speed is based on the oscillating speed of the released charged springs (14), the frequency of the produced A.C. Current passing through the electromagnet's coil (7) will be equal to the frequency of the released charged springs (14). Since the attraction and repulsion forces will start generate immediately between the permanent magnets (4) and electromagnets (5) at frequency equal to the frequency of the A.C. current passing through the electromagnet's coil (7), the magnetic force/energy of the coupled permanent magnets (4) “source of renewable energy” will be applied on the oscillated movable frame (2) and its coupled springs at frequency equal to the frequency of the released springs (14) and in phase with it then transferred it to the rotor's shaft (11), as a result the permanent magnets (4) “source of renewable energy” will keep adding energy to the oscillated kinetic energy inside the springs (14) in phase with its frequency and in line with rotation of the rotor's shaft (11) which helps the system to keep continuously storing kinetic energy inside the oscillated springs (14) and keep rotating the rotor's shaft (11) and keep producing the electric power at load condition as long as the reversed electromagnetic torque produced inside the coupled A.C. electrical generator (10) at load condition is less than the attraction and repulsion force between the permanent's magnets (4) and electromagnets (5a&5b) and the electrical load required energy is less than the permanent's magnet energy according to energy conversion law; Input energy=Loss energy+Output Load energy

To be note, according to the new design of the cell (1) drawing FIG. 5/13 that adding a springs to the cell (1), because the Attraction and repulsion force/energy between the permanent magnets (4) and the electromagnets (5a & 5b) applied in phase to the frame (2) and its coupled released springs (14) at spring's frequency as illustrated above, the system has to be kept under load-condition in order to damping the oscillating system by the loaded A.C. Electrical generator (10) at a certain acceptable level “according to acceptable connected load's power range” that prevent the system to oscillate at high amplitude level and damage.

FIG. 6/13: includes the sub figures (6a, 6b, 6c and 6d) shows the four methods and auxiliary equipment for starting the operation of the present invention system. the present invention system that hold and use the permanent magnets (4) as a Sources of renewable energy for driving the rotor's shaft (11) of the electrical generator (10) and producing the electrical power needs an external starting power produced by external energy source applied to the input of the present invention one time only “at starting only” to accelerate the rotor's shaft (11) to designed speed then decoupling from it during the operation in order to charge the kinetic energy inside the system. once the rotor's shaft (11) reach the system designed/required speed wherein the system full charged with kinetic energy, the external starting power will be decoupled from the system and the system will continuously keep rotate the rotor's shaft (11) at the designed/required speed and keep storing the charged kinetic energy due to permanent magnet force/energy (attraction and repulsion force between the permanent magnets and the electromagnets) that keep adding renewable energy to the system that compensate the system energy loss during the operation and keep feeding the energy to connected electrical load through the electric generator (10) as long as the reversed electromagnetic torque produced inside the coupled A.C. electrical generator (1) at load condition is less than the attraction and repulsion force between the permanent's magnets (4) and electromagnets (5a&5b) and the electrical load required energy is less than the permanent's magnet energy according to energy conversion law; Input energy=Loss energy+Output Load energy

According to formula (4) of the energy conversion and since the permanent's magnets energy is the only source of renewable energy available inside the system we can consider the Permanent magnet's power is the only input renewable power available inside the system that apply to the input of the rotor's shaft (11) of the A.C. electrical generator (10) for continuously producing the electric power in accordance to above mentioned energy conversion law “formula 4”.

To be note the designed/required speed of the charged kinetic energy inside the system is very important factor that decide the output power value of the present invention system, wherein the permanent's magnets power that produced on the movable frame (2) due to oscillation of the permanent magnets (4) between the electromagnets (5a&5b) at oscillating speed and applied to the rotor's shaft (11) “input of the A.C. Electrical generator (10) is equal to forces summation (Fm) of all held permanent magnets (4) inside the system multiply by speed of oscillation V of the permanent magnets (4) between the electromagnets (5a&5b).

Permanent magnet's power=Fm*V or Tm*W (5)

Hence, the permanent magnets power can be increased by the following methods in order to increase the output electrical power of the system;
1. Increasing the total permanent magnetic force according to formula; (F=0.577*B̂2*A where B is the flux density in the gap in kG, and A is the magnet area in square inches) and/or increasing the numbers of cell (1) that hold the permanent magnets (4) inside the present invention system.
2. Increasing the speed (rpm) of rotor's shaft (11) by accelerating the rotor's shaft (11) to highest speed “increasing the speed of the stored kinetic energy inside the system.

The output electrical power produced by the A.C. Electrical generator (10) “E*I” can be increased by increasing its input mechanical Power “P_{mech}” according to following formula (3) related to A.C. Electrical generator;

Input mechanical power (P_{mech})=Output electrical power (P_{elec}) “Considering zero power loss”

T*W=E*I (3)

The following are four methods for starting the present invention system, wherein the first and second method can be considered as mechanical method based on its mechanical equipment and external source of supply, while the third and fourth method can be considered as an electrical method based on its electrical equipment and external source of supply;

The First method for starting the operation of the present invention system as shown under sub figure 6a using the mechanical power as an external power to drive the rotor's shaft (11) to its designed/required speed (in other word, charging the kinetic energy inside the system), wherein the external mechanical power applied to the rotor's shaft (11) by the auxiliary starting mechanism (21) that can be fixed between the generator's foot (22) and the rotor's shaft (11) of electrical generator (10). The auxiliary starting mechanism (21) comprised of main frame (23) and rotating shaft (24) that fixed the two front and back gears/sectors (25,26), a torsion springs (27) are coupled between the rotating shaft (24) and the main frame (23), wherein rotating shaft (24) start rotate due to external mechanical power applied on it via a bolt driver's tool that drive the bolt (35) fixed at the end of the shaft (24) according to external power in order to rotate the shaft (24) and store the potential energy gradually inside the torsion springs (27) and make the gears/sectors (25,26) moves from its normal position (28) to its fully charge position (29) where the tooth's (30) of the gears/sectors (25,26) will be coupled gradually to the rotor's shaft (11) tooth (31) during the charging process of the torsion springs (27), the holding and release mechanism that comprised of the gear (32) fixed on the rotating shaft (24) terminal and the free degree of freedom lead (33) that fixed on the main frame (23) via and spring (34) prevents the charged torsion springs (27) to slip back during the charging process by the driver's tool applied to the bolt (35) that makes the torsion springs (27) charged gradually and safely. once the torsion springs (27) and the driving gears/sectors (25,26) reach fully charged position (29), the holding and release mechanism fix the torsion springs (27) and the gears/sectors (25,26) at fully charged position (29), once the lead (33) moved manually or automatically to decouple from the gear (32), the torsion's springs (27) release its stored potential energy a transfer it as a kinetic energy applied to the rotor's shaft (11) of the electric generator (10) via the gears/sectors (25,26) to drive it at designed Kinetic energy's speed, wherein the gears/sectors (25,26) and the torsion's springs (27) decoupled from the rotor's shaft (11) and return back to its normal position after fully discharging of potential energy inside the torsion's springs (27). To be note, the main frame (23) fixed between the foot of the generator via screw and bolt and/or any other means of fixing methods as shown in subfigure 6a.

The Second method for starting the operation of the present invention system as shown under subfigure 6b using a conventional engine (36) coupled to rotor's shaft (11) of the electrical generator (10) via electrical or mechanical clutch/coupling (37); the engine (36) drives the rotor's shaft (11) of the Non-loaded electric generator (10) to reach the designed/ required speed (in other word, charging the kinetic energy inside the system) then decoupled the engine drive shaft from the rotor's shaft (11) via the coupled clutch (37).

The Third method for starting the operation of the present invention system as shown under sub figure 6c using the electric power as an external power to drive the rotor's shaft to its designed/required speed (in other word, charging the kinetic energy inside the system), wherein the selector switch (16) connected between the external electric power supply (17) and the output of the generator (18), the selector switch has two positions, the motor position (19) and generator position (20), when the selector switch set on motor position (19), the external power supply (17) will feed the coupled synchronous generator (10) that will operate as a motor to drive the rotor's shaft (11) to reach the designed/required speed, at the mean time the external alternating current (15) start passing through the electromagnet's coils (7) also that enhance the starting operation due to start the attraction and repulsion force between the permanent magnets (4) and the electromagnets (5a & 5b) that applied in line to the rotor's shaft (11) via the movable frame (2) and camshaft (13), once the rotor's shaft (11) reach the system designed/required speed, the position of the selector switch will be changed manually or automatically from motor position (19) to generator position (20), the external electric power supply (17) will be disconnected from the system, while the generator output terminals (18) will be connected to the load, wherein the rotor's shaft (11) continuously rotate at the designed/required speed and keep storing the starting kinetic energy due to permanent magnets force/energy (attraction and repulsion force between the permanent magnets (4) and the electromagnets (5a & 5b) as explained in details previously.

The Fourth method for starting the operation of the present invention system as shown under sub figure 6d using the electric power as an external electrical power to drive the rotor's shaft (11) to its designed/required speed (in other word, charging the kinetic energy inside the system), wherein the selector switch (16) connected between the external electric power supply (17) and the output of the generator (18), the selector switch has two positions, the On-Grid position (19d) and Off-Grid position (20d), when the selector switch set on position (19d), the external power supply (17) will feed the electromagnets (5a & 5b) to start producing the attraction and repulsion force between the permanent magnet (4) and the electromagnets (5a & 5b) in order to drive the rotor's shaft (11) to reach the designed/required speed via the movable frame (2) and camshaft (13), once the rotor's shaft (11) reach the system designed/required speed, the position of the selector switch will be changed manually or automatically from On-Grid (19d) to Off-Grid position (20d), the external electric power supply (17) will be disconnected from the system, while the generator output terminals will be connected to the load and to the electromagnets (5), wherein the rotor's shaft (11) continuously rotate at the designed/required speed and keep storing the charged kinetic energy due to permanent magnets force/energy (attraction and repulsion force between the permanent magnets (4) and the electromagnets (5a & 5b) as explained in details previously.

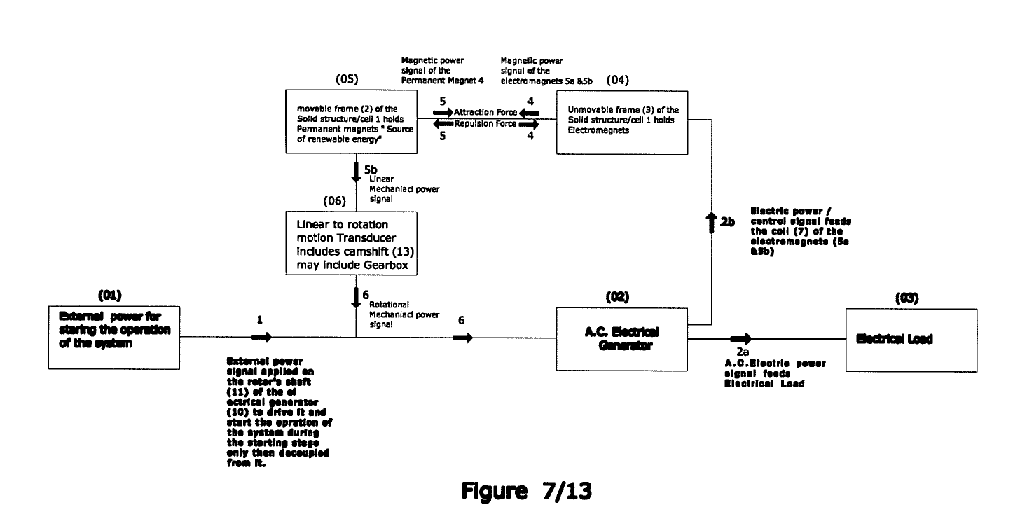

FIG. 7/13: is a schematic block diagram shows the first application of the present invention system (Off-Grid renewable power generating system), related equipment and its connection for driving the coupled A.C. electrical generator (10) via the permanent magnets energy and produce the electric power. Wherein the block 01 represent the external power source that apply the starting power to the rotor's shaft (11) of the A.C. electric generator (10) “block 02” at staring stage only and disconnected during the operation stage in order to start push and accelerate the rotor's shaft (11) to reach the designed/required speed of the system (in other word, charging the kinetic energy inside the system) and start producing the A.C. electrical power by the A.C. electric generator “block 02”, the electrical A.C. Power produced by the A.C. electrical generator “block 02” feeds at same time both the electrical connected load “block 03” and the electromagnets (5a&5b) that fixed on the unmovable frame (3) “block 04” of the present invention solid structure/cell (1), once the current start passing through the electromagnets coil (7), the attraction and repulsion forces start generate between the electromagnets (5a&5b) that fixed on the unmovable frame (3) “block 04” and the permanent magnet (4) “Source of renewable energy” that fixed on the movable frame (2) “block 05” of the present invention solid structure/cell (1), as a result, the movable frame (2) “block 05” starts oscillate in linear motion due to attraction or repulsion force between the permanent magnet (4) of block 05 and the electromagnets (5a&5b) of block 04 in accordance to alternating current signal/polarity produced by the A.C. electric generator “block 02” that pass through the electromagnets coil (7) of the electromagnets (5a & 5b) “block 04” and in accordance to faraday's law and right hand rule), wherein the generated attraction/repulsion force is the summation of the electromagnet's force (4) and the permanent magnet's force (5). The linear motion/mechanical power of the movable frame (2) ‘block 05”

(Mechanical power=Attraction/repulsion force (N)*Oscillating speed V (m/sec) or

(Mechanical power=Attraction/repulsion force (N)*Displacement of the force (mm)*Oscillating frequency W (rad/sec)

will be applied to rotor's shaft (11) of the A.C. Electrical Generator “ block 02” indirectly via linear to rotation motion transducer and camshaft (13) “block 06” that may include reduced speed gear box (38), wherein the coupling position between the camshaft (13) and the rotor's shaft (11) that decide the position of the permanent magnet (4) between the electromagnets (5a&5b) has to be calibrated is such way when the permanent magnet (4) start reverse its linear movement direction, the produced A.C. current passing through electromagnets coil (7) of the electromagnets (5a&5b) start reverse its polarity/direction at same time exactly “accordance to rotation of the rotor's shaft (11) as mentioned previously” in order to matching and adding the mechanical power of the movable frame (2) to the system by applying the mechanical power of the movable frame (2) “block 05” on the rotor's shaft (11) in line with its rotation speed and direction that decided and start by the external power source and its direction “block 01” one time at starting stage only. It is of course, the system needs to be accelerated by the external starting power to reach and pass certain speed “cut in speed according to the design of the system” then disconnected when the input mechanical power of the movable frame (2) “block 05” that produced by the oscillated attraction and repulsion forces/energy between permanent magnets (4) of block 04 and the electromagnets (5a&5b) of block 05 applied continuously to the rotor's shaft (11) according to energy conversion law (Input energy=Loss energy+Output Load energy) and as long as the reversed electromagnetic torque produced inside the coupled A.C. electrical generator (10) at load condition is less than the attraction and repulsion force between the permanent's magnets (4) and electromagnets (5a&5b) and the electrical load required energy is less that the permanent's maenet enerev.
that keep continuously rotating the rotor's shaft (11) and continuously produce the output A.C. electrical power via the permanent magnet (4) energy “available renewable energy source” that keep adding energy to the system to keep driving the rotor's shaft (11) of the coupled A.C. electrical generator (10).

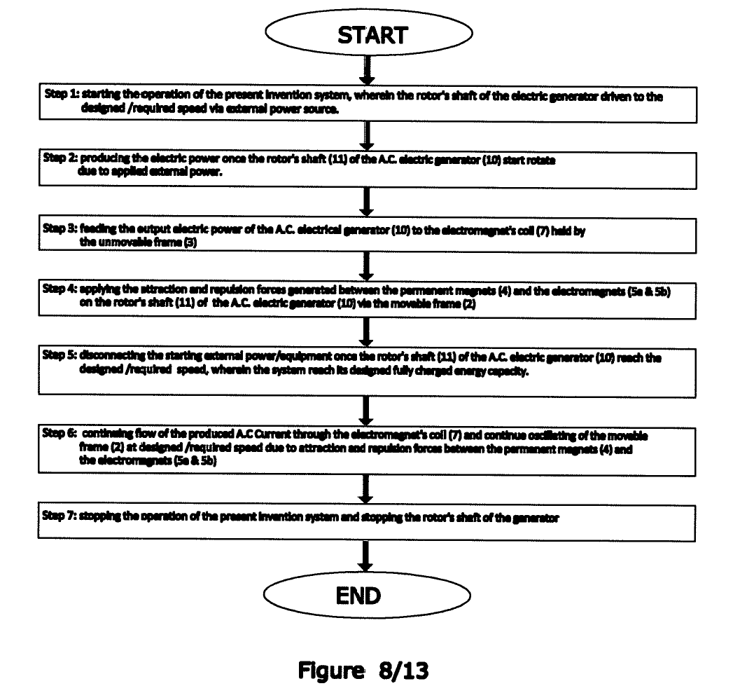

FIG. 8/13: is a flow chart shows the staring and operation's sequence of the present invention system under the first application (Off-Grid renewable power generating system). The flow chart includes the following steps for starting and operating of the present invention;

Step 1: starting the operation of the system by charging the kinetic energy inside the system, wherein the rotor's shaft (11) of the A.C. electric generator (10) driven by an external power source to reach the designed/required speed of the system that exceed the cut in speed required for continually operating the system based on its available permanent magnet's energy (4) “source of renewable energy” only according to one of the above starting method mentioned under FIG. 6/13 and its related explanation, wherein the permanent magnet's energy “renewable energy source” equal or exceed the energy loss of the system plus connected electrical load energy of the system (Permanent magnet's energy=energy loss+electrical load energy) as per the energy conversion low and as long as the electromagnetic force produced inside the coupled A.C. Electrical generator (10) at load condition is less than forces summation of all permanent's magnets (4) available in the system as mentioned previously.

Step 2: producing the electric power once the rotor's shaft (11) of the A.C. electric generator (10) start rotate due to applied external power.

Step 3: feeding the output electric power of the A.C. electrical generator (10) to the electromagnet's coil (7) held by the unmovable frame (3), wherein the alternating current start flows through the electromagnet's coil (7) of both electromagnet (5a&5b) at same time, the attraction and repulsion forces start generate between the permanent magnets (4) and the electromagnets (5a &5b) according to continuous changing on the alternating current signal/polarity from positive to negative and vise versa that change the electromagnetic field polarity of the electromagnets (5a & 5b) from north to south and vise versa according to faraday's law and right hand rule.

Step 4: applying the attraction and repulsion forces generated between the permanent magnets (4) and the electromagnets (5a & 5b) on the rotor's shaft (11) of the A.C. electric generator (10) via the movable frame (2), wherein the movable frame (2) collect all the attraction and repulsion linear forces between the permanent magnets (4) and the electromagnets (5a & 5b) available in the system together and apply it on the rotor's shaft (11) of the A.C. electric generator (10) at rotor's shaft speed and direction via the linear to rotation speed transducer (12) includes camshaft (13) and may use of speed reducing gearbox (38).

Step 5: disconnecting the starting external power/equipment once the rotor's shaft (11) of the A.C. electric generator (10) reach the designed/required speed, wherein the system reach its designed fully charged energy capacity.

Step 6: continuing flow of the produced A.C Current through the electromagnet's coil (7) and continue oscillating of the movable frame (2) at designed/required speed due to attraction and repulsion forces between the permanent magnets (4) and the electromagnets (5a & 5b) that keep applying the permanent magnet force/energy “source of renewable energy” into the system in order to keep storing the charged kinetic energy inside the system and continuing drive the rotor's shaft (11) of the electric generator (10) and continue producing the electric power as long as the reversed electromagnetic torque produced inside the coupled A.C. electrical generator (10) at load condition is less than the attraction and repulsion force between the permanent's magnets (4) and electromagnets (5a&5b) and the electrical load required energy is less that the permanent's magnet energy.

Step 7: stopping the operation of the present invention system and stopping the rotor's shaft of the generator by disconnecting the output electric power of the A.C electric generator (10) or disconnecting only the electromagnet's coils (7) from the output electric power of the A.C electrical generator (10) via selector switch or breaking the rotor's shaft (11) of the A.C. electric generator (10) by certain breaking mechanism.

FIG. 9/13: includes sub figures (9a, 9b, 9c, 9d) shows different design and installation's method of the present invention system. Wherein;

subfigure 9a presents multi cells (1) that extend a long the coupled conventional A.C electrical generator (10) forming the solid structure in order to increase the overall permanent magnets (4) effective area and energy, as a result increase the output electric power of the coupled A.C electrical generator (10).

Subfigure 9b presents one of the design method of the present invention that suit building services, we can easily increase of the permanent magnets number by increasing the coupled cells (1) in order to increase the total permanent magnets and its effective area and energy by extend the solid structure, this can be done by arrange and fixed multi numbers of cells (1) of the solid structure together as shown in subfigure 9b. to be note, although the solid structure of the system has high dimension due to multi numbers of cells (1) which may be considered as difficult to start its operation according to starting methods illustrated under FIG. 6/13, but according to electric circuit diagram of FIG. 2/13, once the rotor's shaft (11) start rotate at driver's speed, the current immediately produced and immediately flows to all connected cells (1) of the present invention at the same time exactly and the forces of all permanents magnets (4) available in the system work together at same time exactly in line with external driver force at its speed which enhance the starting process of the system.

Subfigure 9c present the present invention solid structure coupled to linear A.C electrical generator (10-L), wherein the movable frame (2) is coupled to rotor's shaft (11-L) of the linear electrical generator (10L), while the unmovable frame (3) coupled to its body (9L). The springs (14) coupled between the movable frame (2) and unmovable frame (3) in order to smoothing and adjusting the movement of the rotor's shaft (11) of the electric linear generator (10 L). The system can be started the operation by using external power source for pulling down or pushing up the movable frame (2) gradually and release it for starting the operation of the present invention and producing the A.C. electric power, wherein the rotor's oscillating frequency will be accordance to overall spring's stiffness coefficient (K) and the stored kinetic energy inside the system.

Subfigure 9d present the present invention solid structure coupled to flywheel energy storage (39) in order to get high benefit from the high speed of the flywheel's rotor for producing high electric power due to its high capacity for storing the kinetic energy according to its operation's method, wherein the flywheel will be accelerated to required speed around 40,000 rpm for continues storing the kinetic energy, while the coupled present invention solid structure includes its coupled permanent magnets keep applying the permanent magnet force/energy to flywheel rotor's shaft at its speed of rotation via the movable frame (2) and linear to rotational speed transducer includes camshaft (13) in order to keep storing the kinetic energy inside the flywheel and get high benefit from the high speed of its rotor for producing high electric power through the flywheel according to formula (4) and in accordance to power conversion rule;

Fm*V or Tm*W=I*E (3)

Where Fm; the forces summation of the held permanent magnets inside the present invention system, V; the designed speed of the flywheel rotor's shaft due to stored kinetic energy inside it. To be not, the present's invention solid structure can be installed inside vacuum compartment (40) in order to reduce the power loss and noise of the system during the operation due to high speed and frequency of the flywheel operation.

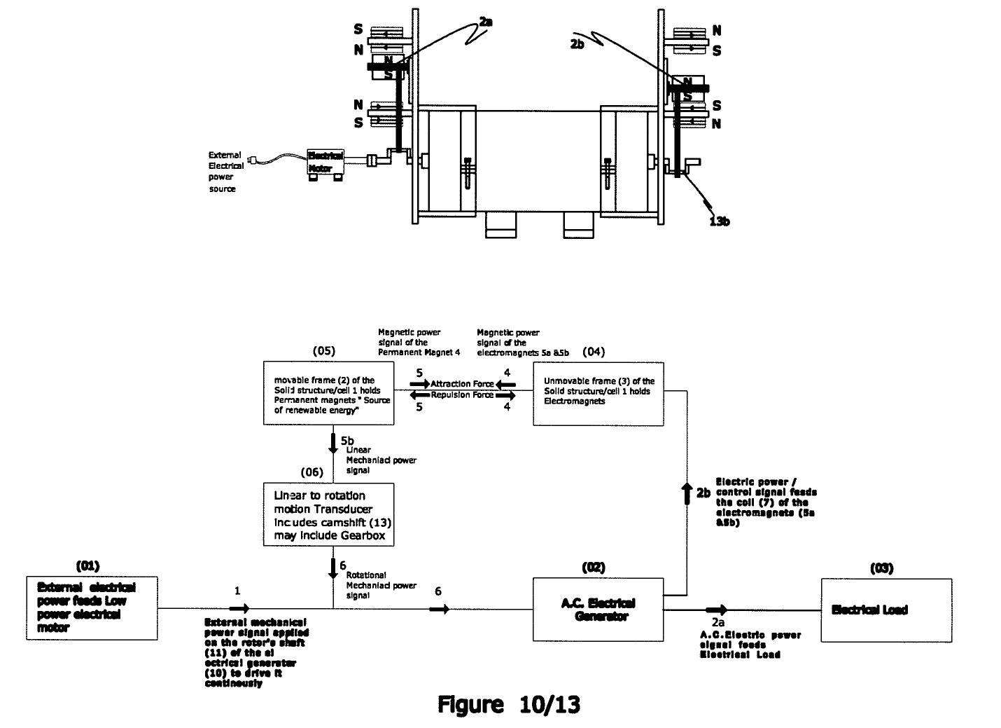

FIG. 10/13: is a schematic block diagram shows the Second application of the present invention system (Off-Grid renewable power generating system), related equipment and its connection that add the magnetic force/energy of the permanent magnets to the mechanical energy produced by electrical energy sources via electrical motor in order to enhance its operation and increase the produced mechanical power applied to the input of the coupled electrical generator (10) by implement the following changes on the present invention system according to its First application illustrated and shown under FIGS. 1/13 to 9/13;
1. Couple low power electrical motor (that feed via external electrical energy source) to the input of the present invention system, wherein the output of the electrical motor drives the rotor's shaft (11) of the coupled A.C. electrical generator (10) continuously during starting stage at no-load condition of the coupled electrical generator (10) for storing the kinetic energy inside the system and reach the required designed speed of the rotor's shaft (11) and also during the operation of the system.

The second application of the present invention adding the magnetic force/energy of the permanent magnets (4) to the mechanical force/energy of the coupled low power electric motor that feed by external electrical power source , wherein once the electrical motor start operate, the rotor's shaft (11) will start rotate at electrical motor's speed and the current produced via the A.C electrical generator (10) start flows to the electromagnets (5a & 5b), the attraction and repulsion force start generate between the permanent magnets (4) and the electromagnets (5a & 5b) and the permanent magnets (4) start oscillate between the electromagnets (5a & 5b) at frequency (cycle/min) equal to the A.C. current frequency (Cycle/min) and rotor's shaft (rpm) of the A.C. electrical generator (10) as illustrated under the description of FIGS. 3/13 & 4/13 and equal to the coupled electrical motor's speed, wherein the generated attraction and repulsion forces/energy is a summation of force/energy of the permanent magnets (4) “source of renewable energy” and the force/energy of the electromagnets (5a & 5b). The attraction and repulsion forces/energy applied in phase to the rotor's shaft (11) of the A.C. electrical generator (10) via the movable frame (2) and linear to rotational speed transducer includes camshaft (13) that enhance the rotation of the rotor's shaft (11), hence the output electrical energy produced by the A.C. electrical generator (10) will be according to following energy conversion low;

Input energy=loss energy+output energy

External electrical energy source drives the A.C. electrical generator via the electrical motor+Renewable energy of the permanent magnets (4)=loss energy of the system+electrical load energy.

The system will keep adding/mixing the mechanical energy produced by the electrical motor with the permanent magnets energy and apply it together to the input of the A.C. electrical generator (10) as long as the reversed electromagnetic torque produced inside the coupled A.C. electrical generator (10) at load condition is less than the attraction and repulsion forces produced between the permanent magnets (4) and electromagnets (5a&5b) plus the mechanical energy produced by electrical motor that drive the rotor's shaft (11) and the system work according to below energy conversion law.

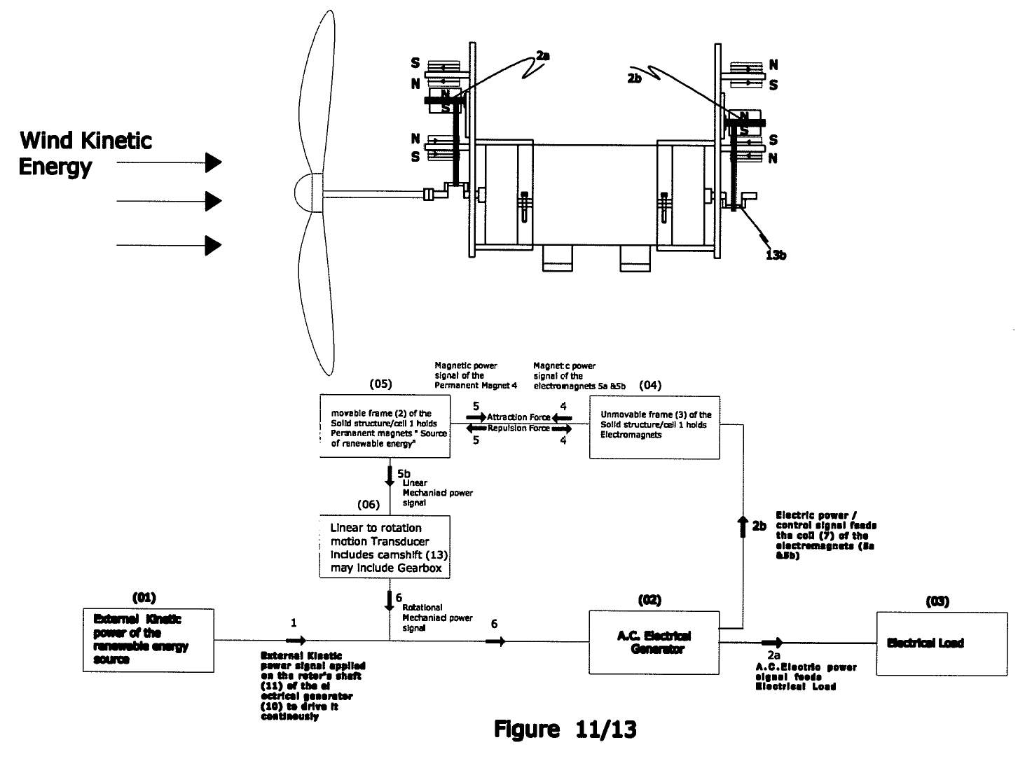

FIG. 11/13: is a schematic block diagram shows the Third application of the present invention system (Mechanical power magnifying system), related equipment and its connection that add the magnetic force/energy of the permanent magnets to the kinetic energy produced by renewable energy sources such as wind Wave Sea and etc. . . . via its related turbine in order to enhance its operation and increase the produced mechanical power applied to the input of the coupled electrical generator by implement the following changes on the present invention system according to its First application illustrated and shown under FIGS. 1/13 to 9/13;
1. Remove the starting equipment from the present invention since it is not required in such application to charging the kinetic energy inside the system, wherein the system able to start its operation via the coupled kinetic energy of renewable energy source.
2. Couple the output of the turbine that collected the renewable energy source to the camshaft (13) (input of the present invention) in order to drive the rotor's shaft (11).
   The second application of the present invention adding the magnetic force/energy of the permanent magnets (4) to the mechanical force/energy of the coupled renewable energy source that rotate the coupled turbine, wherein once the input renewable kinetic energy applied to the turbine, the rotor's shaft (11) will start rotate at turbine speed and the current produced via the A.C electrical generator (10) start flows to the electromagnets (5a & 5b), the attraction and repulsion force start generate between the permanent magnets (4) and the electromagnets (5a & 5b) and the permanent magnets (4) start oscillate between the electromagnets (5a & 5b) at frequency (cycle/min) equal to the A.C. current frequency (Cycle/min) and rotor's shaft (rpm) of the A.C. electrical generator (10) as illustrated under the description of FIGS. 3/13 & 4/13, wherein the attraction and repulsion forces/energy is a summation of force/energy of the permanent magnets (4) “source of renewable energy” and the force/energy of the electromagnets (5a & 5b). The attraction and repulsion forces/energy applied in phase to the rotor's shaft (11) of the A.C. electrical generator (10) via the movable frame (2) and linear to rotational speed transducer includes camshaft (13) that enhance the rotation of the rotor's shaft (11), hence the output electrical energy produced by the A.C. electrical generator (10) will be according to following energy conversion low;

Input energy=loss energy+output energy

Renewable kinetic energy drives the A.C. electrical generator+Renewable energy of the permanent magnets (4)=loss energy of the system+electrical load energy.

The system will keep magnifying External renewable kinetic energy that apply to A.C. electrical generator (10) as long as the reversed electromagnetic torque produced inside the coupled A.C. electrical generator (10) at load condition is less than the attraction and repulsion forces produced between the permanent magnets (4) and electromagnets (5a&5b) plus the renewable kinetic energy that drive the rotor's shaft (11) and the system work according to below energy conversion law.

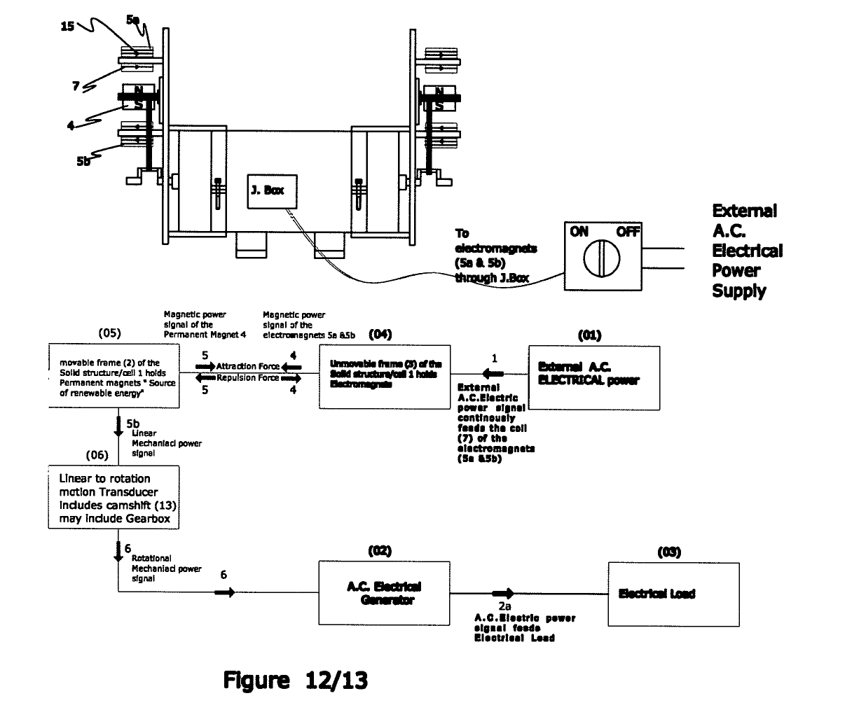

FIG. 12/13: is a schematic block diagram shows the Fourth application of the present invention system (electrical power magnifying system), related equipment and its connection for magnifying the input grid's electrical energy by add it to the permanent magnet energy in order to increase the electrical power feeds the electrical loads, wherein the grid external A.C. electrical power applied continuously to the electromagnets (5a & 5b) available inside the system by implement the following changes on the present invention system according to its First application illustrated and shown under FIGS. 1/13 to 9/13;
1. Disconnecting the connection between the output terminals of the A.C. Electrical generator (10) and the electromagnets (5a&5b).
2. Feeding the grid external A.C electrical power that required to be magnified to the electromagnets (5a&5b) continuously.
3. Remove the starting equipment from the present invention since it is not required in such application to charging the kinetic energy inside the system, wherein the system able to start its operation via the feed grid external A.C electrical power of point 2 only.

The second application of the present invention mixing the magnetic force/energy of the permanent magnets (4) with the electromagnetic force/energy of the electromagnets (5a & 5b) that generated by the external input A.C. electrical power source that continuously applied to the system in order to be magnified, wherein once the grid external input A.C. electrical power connected and apply to the electromagnets (5a & 5b), the attraction and repulsion force start generate between the permanent magnets (4) and the electromagnets (5a & 5b) and the permanent magnets (4) start oscillate between the electromagnets (5a & 5b) at frequency of the connected external input A.C. electrical power, wherein the attraction and repulsion forces/energy is a summation of force/energy of the permanent magnets (4) “source of renewable energy” and the force/energy of the electromagnets (5a & 5b) that generated via the external input A.C. electrical power. The attraction and repulsion forces/energy applied to the rotor's shaft (11) of the A.C. electrical generator (10) via the movable frame (2) and linear to rotational speed transducer includes camshaft (13), hence the output electrical energy produced by the A.C. electrical generator (10) will be according to following energy conversion low;

Input energy=loss energy+output energy

External energy apply to electromagnets (5a&5b)+Renewable energy of the permanent magnets (4)=loss energy of the system+output electrical energy

The system will keep magnifying External A.C electrical power apply to electromagnets (5a&5b) as long as the reversed electromagnetic torque produced inside the coupled A.C. electrical generator (10) at load condition is less than the attraction and repulsion forces produced between the permanent magnets (4) and electromagnets (5a&5b) that drive the rotor's shaft (11) and the system work according to below energy conversion law.

To be note, according to third application of the present invention the A.C. electrical generator (10) can be replaced by D.C. electrical generator in order not only to magnify the External A.0 electrical power that apply to electromagnets (5a&5b), but also to convert it into D.C. electrical power.

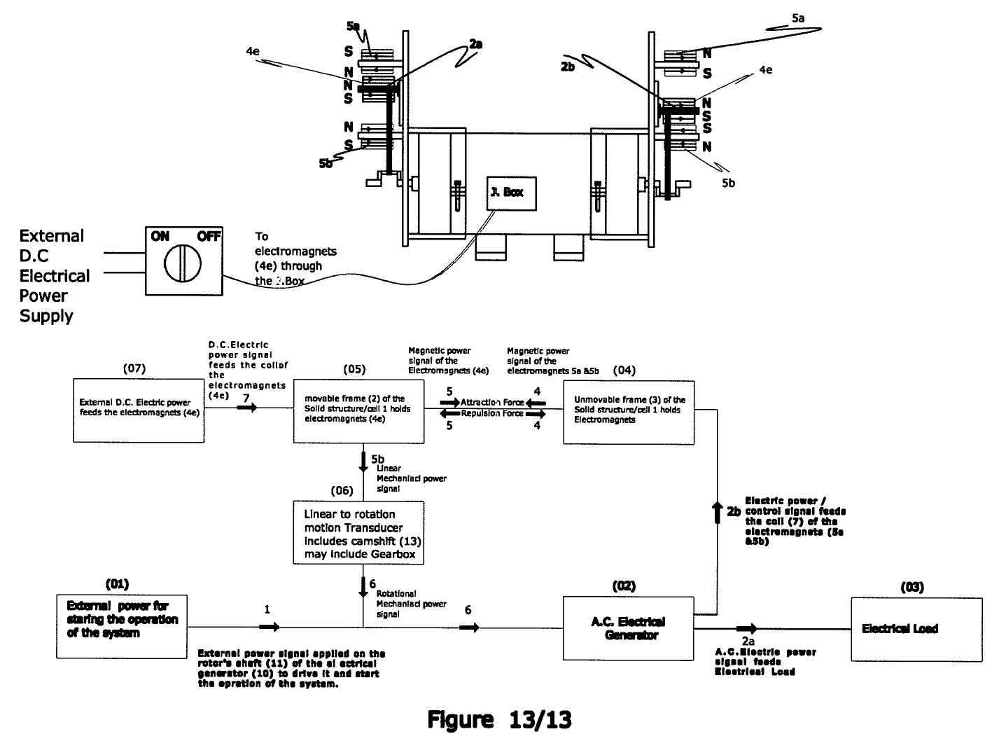

FIG. 13/13: is a schematic block diagram shows the Fifth application of the present invention system (Electrical Inverter system), related equipment and its connection for converting the input D.C electrical power into output A.C. electrical power by implement the following one change only on the present invention system according to its First application and Second application illustrated and shown under FIGS. 1/13 to 10/13;
1. Replacing the permanent magnets (4) “Source of the renewable energy” with the electromagnets (4e) that feed continuously via an external input D.C electrical power source.

The starting and operation process of present invention system under this fifth application is exactly as same as to its starting and operation process under its first application and second application illustrated and explained under FIGS. 1/13 to 10/13, but by implement the above mentioned change on the system, wherein under such change the electromagnets 4e that feed continuously via external D.C Electric power replaced the permanent magnets (4), the system will start and operate similar to first application and second application of the present invention on charging the kinetic energy inside the system, the External input D.C. electric energy applied to electromagnets (4e) will be converted into magnetic force/energy that keep adding energy to the system to drive the rotor's shaft (11) of the A.C. Electrical generator (10) and produce the A.C. electrical power at frequency equal to oscillated frequency of the electromagnets (4e) and its movable frame (2) that in accordance to the speed of the charged kinetic energy inside the system as long as the reversed electromagnetic torque produced inside the coupled A.C. electrical generator (1) at load condition is less than the attraction and repulsion force between the electromagnets (4e) and electromagnets (5a&5b) and the electrical load required energy is less that the electromagnets (4e) energy according to energy conversion law;

1. A method for building and operating an extendable compact solid structure that has one or a plurality of permanent magnets for driving it's rotor shaft efficiently via continuous external input power plus the renewable magnetic force/energy of the permanent magnets comprising;
Having one or a plurality of permanent magnets as a renewable energy source and one or a plurality of electromagnets in one solid cell that includes a movable frame being movable relative to an unmovable frame; and
Extending the solid structure by coupling a plurality of cells together, wherein the movable frames of neighbor's cells are coupled together and the unmovable frames of neighbor's cells are coupled together also; and
Optionally fixing the unmovable frames of the solid structure on the body of the electric generator; and
Coupling the entire movable frames of the solid structure to the rotor's shaft of the electric generator indirectly via a linear to rotation speed transducer that includes a crank and may include a gearbox, or directly by using a linear electrical generator; and
Driving the rotor's shaft of the electric generator via the attraction/repulsion magnetic force/energy generated between at least one permanent magnet and at least one electromagnet due to alternating current passing through the coil of the one or plurality of electromagnets, wherein there is no perpendicular intersection between the magnetic field of the permanent magnets (4) and the coils (7) of the electromagnetic (5a, 5b), as a consequences there is no Electro Motive Force (EMF) generated at the coils (7) of the electromagnets (5a, 5b).

2. A method as in claim 1, wherein the permanent magnets can be fixed on the movable frame of the cell and the electromagnets fixed on unmovable frame and vice versa.

3. A method as in claim 1, wherein springs may be coupled between the movable frame and unmovable frame.

4. A method as in claim 1, where in a flywheel can be coupled to the rotor shafts of the coupled electrical generator in order to store the kinetic energy inside the system after disconnecting the external input power once the rotor's shaft reaches its designed speed.

5. A method as in claim 4, wherein the external power could be mechanical power applied to the rotors shaft via mechanical mechanism/equipment or electrical power applied to the input of the coupled electric generator of claim 1 to drive its rotor's shaft.

6. A method as in claim 1, wherein the movable frame of the solid cell start oscillate in line with the rotors' shaft direction and speed due to attraction and repulsion force between the permanent magnets and electromagnets that applied to the rotor's shaft in accordance to polarity changing of the alternating current passing through the electromagnets.

7. A method as in claims 1 and 4, wherein the attraction force and repulsion force between the permanent magnets and the electromagnets drives the rotors shaft of the electrical generator through the movable frame of the solid structure during coupling and/or decoupling of the starting external Power.

8. A method as in claims 1 to 7, wherein the external electrical power applied continuously to the input of the electrical generator, preferably via electrical motor in order to add to the magnetic energy of the permanent magnets.

9. A method as in claims 1 to 7, wherein the external mechanical power such as renewable kinetic energy applied continuously to the input of the electrical generator can be increased by adding/mixing it to the magnetic energy of the permanent magnets.

10. A method as in claims 1 to 7, wherein the external A.C. electrical power that applied continuously to the input of the electromagnets can be magnified by adding/mixing it to the magnetic energy of the permanent magnets.

11. A method as in claims 1 to 7, wherein by replacing the permanent magnets with the electromagnets (4e), the external D.C. electrical power that applied continuously to the input of the electromagnets (4e) can be converted into electromagnetic force/energy add to the magnetic force/energy of the electromagnets (5) and applied to the rotor's shaft in order to drive it after start charging the kinetic energy inside the system, where there is no perpendicular intersection between the magnetic field of the electromagnets (4e) and the coils (7) of the electromagnetic (5a, 5b) and vies versa, as consequences there is no EMF generated neither at the coils (7) of the electromagnets (5a, 5b) or the coils of the electromagnets (4e))

12. A method as in claim 11, wherein the electromagnetic energy of the electromagnets (4e) converted into A.C. electrical energy via the A.C. Electrical generator.

13. A method as in claims 1 to 7, wherein the A.C. electrical generator can be replaced with flywheel energy storage that can be extend its vacuumed compartment to include the solid structure of claim 1.

14. A system for driving an electrical generator including an extendable compact solid structure that has one or a plurality of permanent magnets for driving the rotor shaft of the electrical generator efficiently via continuous external input power plus the renewable magnetic force/energy of the one or plurality of permanent magnets, comprising;
one or a plurality of permanent magnets as a renewable energy source and one or a plurality of electromagnets in one solid cell that includes a movable frame being movable relative to an unmovable frame; and
a solid structure coupling a plurality of cells together, wherein the movable frames of neighbor's cells are coupled together and the unmovable frames of neighbor's cells are coupled together also; and
the unmovable frames of the solid structure being optionally fixed on the body of the electric generator; and
the entire movable frames of the solid structure being coupled to the rotor's shaft of the electric generator indirectly via a linear to rotation speed transducer that includes a crank and may include a gearbox, or directly by using a linear electrical generator; and
the rotor's shaft of the electric generator being driven via the attraction/repulsion magnetic force/energy generated between at least one permanent magnet and at least one electromagnet due to alternating current passing through the coil of the one or plurality of electromagnets, wherein there is no perpendicular intersection between the magnetic field of the permanent magnets (4) and the coils (7) of the electromagnetic (5a, 5b), as a consequences there is no Electro Motive Force (EMF) generated at the coils (7) of the electromagnets (5a, 5b).

15. A system as in claim 14, wherein the permanent magnets can be fixed on the movable frame of the cell and the electromagnets fixed on unmovable frame and vies versa.

16. A system as in claim 14, wherein the springs may be coupled between the movable frame and unmovable frame.

17. A System as in claim 14, where in a flywheel can be coupled to the rotor shafts of the coupled electrical generator in order to store the kinetic energy inside the system after disconnecting the external input power once the rotor's shaft reaches its designed speed.

18. A system as in claim 17, wherein the starting equipment could be mechanical equipment feed from external energy source that applied to the rotors shaft or electrical equipment from external energy source that applied to the input of the coupled electric generator of claim 1 to drive its rotor's shaft.

19. A system as in claim 14, wherein the movable frame of the solid cell start oscillate in line with the rotors' shaft direction and speed due to attraction and repulsion force between the permanent magnets and electromagnets in accordance to polarity changing of the alternating current passing through the electromagnets.

20. A system as in claims 14 and 17, wherein the attraction force and repulsion force between the permanent magnets and the electromagnets drives the rotors shaft of the electrical generator through the movable frame of the solid structure during coupling and/or decoupling of the starting equipment.

21. A system as in claims 14 to 19, wherein the external electrical power applied continuously to the input of the electrical generator via electrical motor add to the magnetic energy of the permanent magnets held by the solid structure to drive the coupled electrical generator.

22. A system as in claims 14 to 19, wherein the external mechanical power such as renewable kinetic energy applied continuously to the input of the electrical generator can be increased by adding/mixing it to the magnetic energy of the permanent magnets held by the solid structure.

23. A system as in claims 14 to 19 wherein the external A.C. electrical power that applied continuously to the input of the system through the electromagnets can be magnified by adding/mixing it to the magnetic energy of the permanent magnets held by the solid structure.

24. A system as in claims 14 to 19, wherein by replacing the permanent magnets with the electromagnets (4e), the external D.C. electrical power that applied continuously to the input of the electromagnets (4e) converted into electromagnetic force/energy add/mix to the magnetic force/energy of the electromagnets (5) and applied to the rotor's shaft in order to drive it after charging the kinetic energy inside the system by external energy source, where there is no perpendicular intersection between the magnetic field of the electromagnets (4e) and the coils (7) of the electromagnetic (5a, 5b) and vies versa, as consequences there is no EMF generated neither at the coils (7) of the electromagnets (5a, 5b) or the coils of the electromagnets (4e))

25. A System as in claim 24, wherein the electromagnetic energy of the electromagnets (4e) converted into A.C. electrical energy via the A.C. Electrical generator.

26. A system as in claims 14 to 19, wherein the A.C. electrical generator can be replaced with flywheel energy storage, wherein its vacuumed compartment extended to include the solid structure of present invention includes its permanent magnets and electromagnet

27. A method as in claim 1, wherein the extendable compact solid structure/cell (1) and its coupled electromagnets/permanent magnets having cylindrical/arc-shape or others that may be able to provide closed path for distributing the magnetic field inside the ferromagnetic cell (1) similar to the stator of conventional electrical machine in order to uniform the distributed magnetic field inside the ferromagnetic cell (1) which increase the efficiency of the system.

28. A system as in claim 14, wherein the extendable compact solid structure/cell (1) and its coupled electromagnets/permanent magnets having cylindrical/arc-shape or others that may be able to provide closed path for distributing the magnetic field inside the ferromagnetic cell (1) similar to the stator of conventional electrical machine in order to uniform the distributed magnetic field inside the ferromagnetic cell (1) which increase the efficiency of the system.
